(19) United States
(12) Patent Application Publication
(10) Pub. No.: US 2013/0091973 A1
(43) Pub. Date: Apr. 18, 2013

(54) ACCELERATOR

(71) Applicant: Takayuki Kato, Saitama (JP)

(72) Inventor: Takayuki Kato, Saitama (JP)

(73) Assignee: HUSQVARNA AB, Huskvarna (SE)

(21) Appl. No.: 13/806,211

(22) PCT Filed: Jun. 17, 2011
(86) PCT No.: PCT/JP2011/003481

§ 371 Date: Dec. 21, 2012

(30) Foreign Application Priority Data
Jun. 28, 2010 (JP) PCT/JP2010/004277

(51) Int. Cl. G05G 1/04

(52) U.S. Cl. CPC G05G 1/04
USPC 74/483 R

(57) ABSTRACT

An accelerator (1) for adjusting an output of an engine includes: a throttle lever (4) that is turned; a rotating member (16) that is turned in conjunction with the throttle lever (4); a gear member (18) that is concentrically and freely fitted to the rotating member (16); a lock lever (24) that is engaged with the gear member (18) to lock a movement of the gear member (18); a trigger lever (5) that moves the lock lever (24); and an elastic member (22) that frictionally engages the rotating member (16) and the gear member (18). The throttle lever (4) is biased toward an idling position within an output adjustment rage of the engine. The frictional force caused by the elastic member (22) between the rotating member (16) and the gear member (18) is greater than the biasing force of the throttle lever (4) toward the idling position.

### TECHNICAL FIELD

The present invention relates to an accelerator. Specifically, it relates to an accelerator used for a portable work machine.

### BACKGROUND ART

Various portable work machines such as a brushcutter, a chainsaw and a hedge trimmer conventionally employ an engine as a power source. Such a portable work machine has an accelerator with a throttle lever. The throttle lever is operated to adjust an opening degree of a throttle valve provided on a carburetor and the like through a throttle adjustment cable in the form of a Bowden cable. In order to power up the engine, an operator operates the throttle lever from an idling position to a high-rotation position within an output adjustment position.

Such an accelerator includes a friction type accelerator, trigger type accelerator and a twin-throttle type accelerator (see Patent Literature 1).

In a friction type accelerator, the throttle lever is retained at a high-rotation position during operation by a frictional force until an operator is to return the throttle lever to an idling position. Thus, when an operator hopes to immediately return an engine speed to an idling state, the throttle lever has to be turned from the high-rotation position to the idling position, thus requiring complicated operations.

On the other hand, in a trigger type accelerator, the throttle lever is biased toward the idling position. Accordingly, when the throttle lever is returned from the high-rotation position to the idling position, it is only required for an operator to release the throttle lever, thus providing excellent operability. In contrast, however, an operator is forced to constantly hold the throttle lever against the biasing force during an operation in which the throttle lever is shifted toward the high-rotation position. Accordingly, the operator may feel weary or stressed out after long operational durations.

### CITATION LIST

### Patent Literature

[PTL 1] Specification of U.S. Pat. No. 6,182,524

### SUMMARY OF INVENTION

### Technical Problem

Twin-throttle type throttle levers are a combination of the friction type and the trigger type throttle levers to incorporate the advantages of both.

However, in the twin-throttle type accelerator described in the specification of the above-described US patent, since the trigger lever is directly connected to a Bowden cable and is biased to a return side, when the trigger lever is kept being gripped, an operational load applied on the operator considerably increases. Thus, the operator may get exhausted during long operational durations.

Further, the twin-throttle type lever does not have any safety means to prevent an accidental actuation of the throttle lever.

In addition, when the trigger lever is returned even slightly, the engine instantaneously responds to decrease the engine speed, which may result in the stop of the engine according to the circumstances.

An object of the invention is to provide an accelerator that can considerably reduce an operational load.

### Solution to Problem

An accelerator according to an aspect of the invention adjusts an output of an engine, the accelerator including: a throttle lever that is turned; a rotating member that is rotated together with the throttle lever; a gear member that is loosely and concentrically fitted to the rotating member; a lock lever that is engaged with the gear member to lock a movement of the gear member; a trigger lever that moves the lock lever; and an elastic member that frictionally engages the rotating member and the gear member, in which the throttle lever is biased toward an idling position within an output adjustment range of the engine, and a frictional force generated by the elastic member between the rotating member and the gear member is greater than a biasing force of the throttle lever toward the idling position.

With the above-described accelerator, the Bowden cable extending from the carburetor of the engine is, for instance, connected to the rotating member.

According to the above arrangement, since the gear member is locked by the lock lever, the operator operates the throttle lever against the frictional force between the gear member and the rotating member. However, since the frictional force is greater than the biasing force for biasing the rotating member toward the idling position, the operated throttle lever can be retained at an operational position by the frictional force. On the other hand, when the trigger lever is operated to release the locking of the gear member by the lock lever, the rotating member and the throttle lever integrated thereto can be instantaneously returned toward the idling position by the biasing force.

Accordingly, the advantages of the conventional friction type and trigger type accelerators can be attained, thereby reducing the load applied on an operator. Further, since it is not necessary to connect a Bowden cable to the trigger lever, no load is applied on the trigger lever when the lever of the trigger lever is operated, thereby significantly reducing the operational load.

In the accelerator according to the above aspect of the invention, the trigger lever is preferably provided with an engagement arm that is engaged with and disengaged from the rotating member in accordance with an operating condition on the trigger lever. In the above, the trigger lever may be engaged with the rotating member when the trigger lever is not operated while the engine is idling. With the above arrangement, the rotating member can be locked by the trigger member and the throttle lever interlocked with the rotating member can consequently be locked.

Accordingly, even when an operator inadvertently touches the throttle lever during an idling state, the throttle lever is not operated, thereby securely preventing accidental drive of the engine (e.g. engine blow).

In the accelerator according to the above aspect of the invention, the trigger lever is preferably provided with a grip and an engagement arm that is provided as a body independent of the grip and is engaged with the rotating member, and the engagement arm and the lock lever may be integrally provided.

In the accelerator according to the above aspect of the invention, the trigger lever and the lock lever are preferably concentrically turned and are engaged so that the trigger lever and the lock lever are interlocked, and a predetermined amount of backlash is preferably created at an engaged portion of the trigger lever and the lock lever.

Since the trigger lever and the lock lever are interlocked, a slight and unintentional movement of the trigger lever may result in the movement of the lock lever. Then, while the grip over the trigger lever is loosened when the throttle lever is positioned at a high-rotation side, the lock lever is disengaged from the gear member in response thereto and the throttle lever returns to lower the engine speed, resulting in an unstable output.

In contrast, since the predetermined backlash is present between the trigger lever and the lock lever, some fluctuation of the trigger lever can be absorbed by the backlash. Thus, the engine output can be stabilized without affecting the throttle lever, thereby improving the usability of the trigger lever.

In the accelerator according to the above aspect of the invention, the trigger lever is preferably biased in a direction for returning from an operating position, the lock lever is preferably biased in a direction for locking the gear member, and the biasing direction of the trigger lever and the biasing direction of the lock lever are preferably opposite.

According to the above arrangement, since the operation of the trigger lever is assisted by the biasing force of the lock lever, the operation load can be further reduced.

In the accelerator according to the above aspect of the invention, the throttle lever and the rotating member are preferably concentrically turned.

According to the above arrangement, since the throttle lever is concentrically arranged in addition to the rotating member and the elastic member, the components can be densely disposed, thereby reducing the size of a rotary mechanism of the throttle lever.

In the accelerator according to the above aspect of the invention, the throttle lever and the rotating member are preferably mutually connected by a bolt and a nut that are screwed along a rotary axis direction, a lever-side cylindrical portion extending toward the rotating member is preferably provided on the throttle lever, the rotating member is preferably provided with a shaft extending toward the throttle lever, the gear member and the elastic member are preferably inserted to an outer circumference of the lever-side cylindrical portion, and the shaft of the rotating member is preferably inserted to an inside of the lever-side cylindrical portion.

In the accelerator according to the above aspect of the invention, a base end of the lock lever is preferably offset to a first side in the rotary axis direction relative to a distal end thereof, a connecting section at which a Bowden cable for transmitting a movement of the throttle lever to the engine is connected is preferably provided on the rotating member, and the Bowden cable is preferably attachable and detachable through a second side of the rotary axis direction.

In the accelerator according to the above aspect of the invention, the gear member is preferably provided with a gear portion to which the lock lever is engaged and a disk that has a diameter than a diameter of the gear portion and is in frictional engagement with the elastic member, the gear portion and the disk being integrated.

In the accelerator according to the above aspect of the invention, a planar portion that covers an engagement portion of the lock member that is engaged with the gear member is preferably provided on the rotating member.

The accelerator according to the above aspect of the invention preferably includes a case for housing the rotating member, the gear member, the elastic member and the lock lever, and a first rib that is adjacent to and opposed to the lock lever in the rotary, axis direction is preferably provided inside the case.

The accelerator according to the above aspect of the invention preferably includes a case for housing the rotating member, the gear member, the elastic member and the lock lever, in which the trigger lever is preferably provided with an engagement arm that is housed in the case and is engaged with the rotating member, and a second rib that is adjacent to and opposed to the engagement arm in the rotary axis direction is preferably provided inside the case.

The accelerator according to the above aspect of the invention preferably includes a case for housing the rotating member, the gear member, the elastic member and the lock lever, in which the trigger lever is preferably provided with a rotary portion in the case and a grip at a portion extending toward an outside of the case, the case is preferably provided with an abutment portion that is in contact with the grip in the rotary axis direction, and a space is preferably formed between a rotary shaft of the trigger lever and a rotary shaft of the lock lever when the grip is in contact with the abutment portion.

### BRIEF DESCRIPTION OF DRAWINGS

FIG. 1 is a perspective view showing an entirety of an accelerator with a part thereof being cut according to a first exemplary embodiment of the invention.

FIG. 2 is a lateral elevation showing an interior of the accelerator.

FIG. 3 is a cross section showing a primary part of the accelerator.

FIG. 4 is a perspective view enlarging a portion surrounded by a circle IV in FIG. 1.

FIG. 5 is a lateral elevation showing components of the accelerator.

FIG. 6 is a plan view showing the components.

FIG. 7 is a lateral elevation showing an inside of an accelerator according to a second exemplary embodiment of the invention.

FIG. 8 is a cross section taken along arrows VIII-VIII in FIG. 7.

FIG. 9 is a cross section taken along arrows IX-IX in FIG. 7.

FIG. 10 is a cross section showing a primary part of the accelerator according to the second exemplary embodiment.

FIG. 11 is a cross section showing the primary part of the accelerator viewed in a different direction.

FIG. 12 illustrates an engagement portion between the rotating member and the engagement arm in the second exemplary embodiment.

### DESCRIPTION OF EMBODIMENTS

### First Exemplary Embodiment

A first exemplary embodiment of the invention will be described below with reference to the attached drawings.

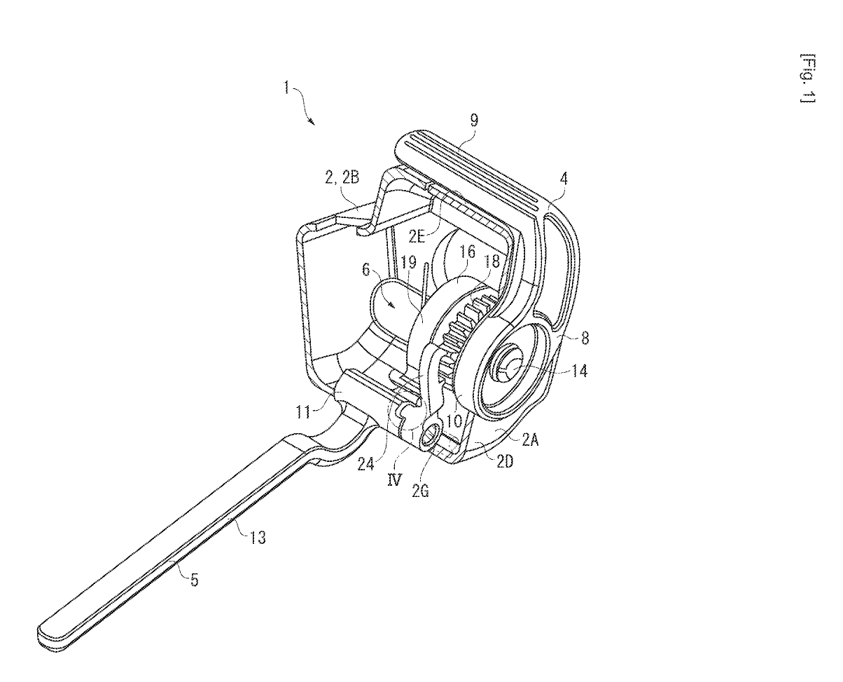

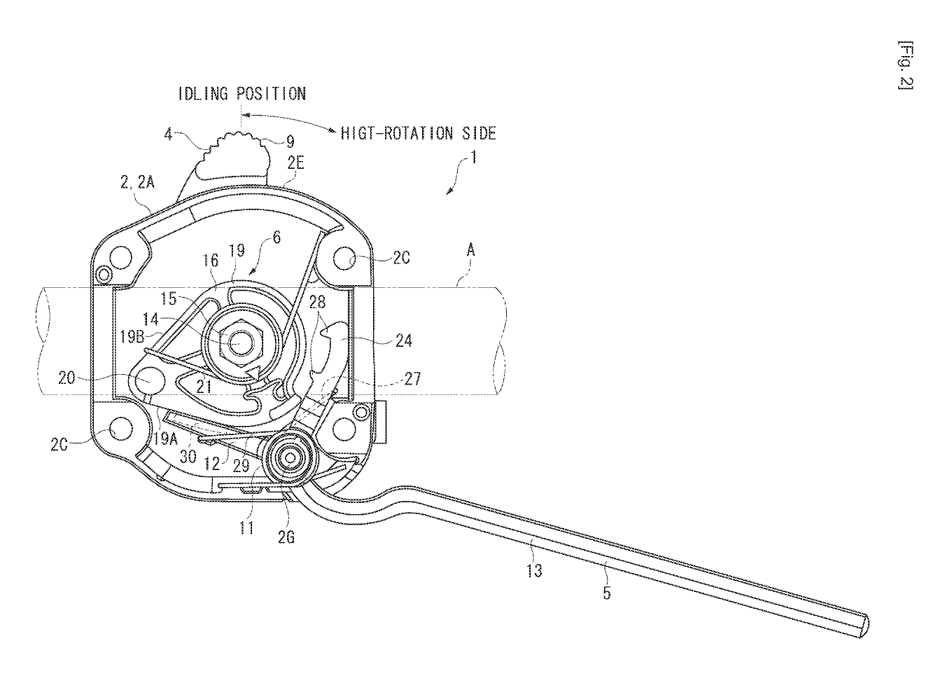

An accelerator 1 according to this exemplary embodiment as shown in FIGS. 1 and 2 is a device used for, for instance, a brushcutter, which is used for adjusting an output of an engine of the brushcutter by operating a throttle of a carburetor attached to the engine.

Specifically, the accelerator 1 includes: a hollow case 2 into which an outer pipe A (shown in two-doted chain line in FIG. 2) of the brushcutter is inserted; a throttle lever 4 and a trigger lever 5 respectively rotatably attached to the case; and a rotary mechanism 6 housed within the case 2 for turning the throttle lever 4.

The case 2 is provided by a pair of case members 2A, 2B that hold the outer pipe A in right and left directions (dual divided structure). The case members 2A, 2B are mutually connected by nuts and bolts inserted into four bolt holes 2C (only the bolt holes 2C on the case member 2A are illustrated) to hold the outer pipe A.

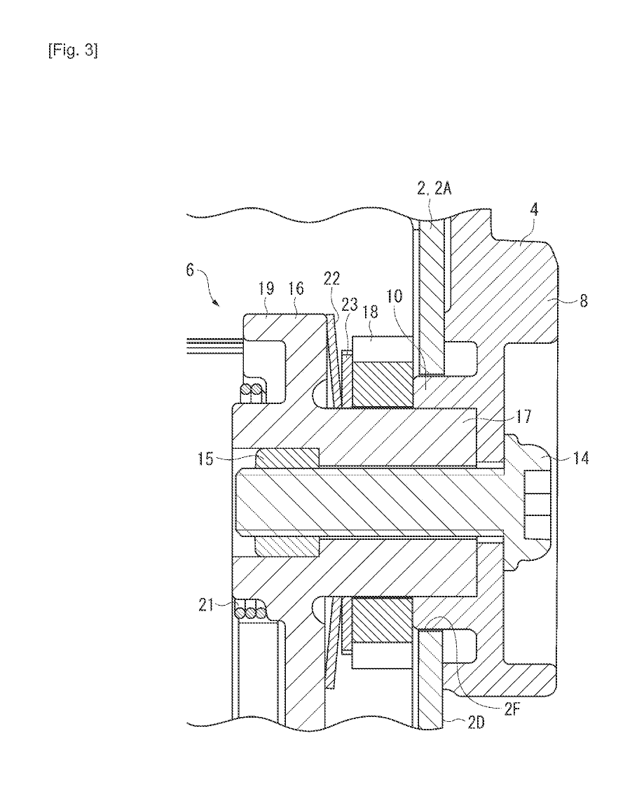

The throttle lever 4 is an operation member for adjusting a throttle opening degree of the carburetor via the rotary mechanism 6 by an operation by a user. As shown in FIG. 3, the throttle lever 4 includes: a base end 8 opposed to a lateral side 2D of the case 2; and an operating portion 9 provided on a distal end of the base end 8 and opposed to a curved upper face 2E of the case 2. The base end 8 and the operating portion 9 are integrated approximately at a right angle. A cylindrical fitting portion 10 that is rotatably fitted to a circular opening 2F of the case 2 is provided at the base end 8 of the throttle lever 4.

The trigger lever 5 switchably disables and enables the throttle lever 4 and serves as a trigger member for instantaneously returning the throttle lever 4 retained at the high-rotation position toward the idling position. The trigger lever 5 includes: a cylindrical portion 11 fitted in a core 20 provided within the case 2 (FIG. 1); an engagement arm 12 being integrated with the cylindrical portion 11 and housed within the case 2; and a grip 13 integrated with the cylindrical portion 11, the grip 13 extending in a direction opposite to the engagement arm 12 to be projected to an outside of the case 2.

The detailed structure of the trigger lever 5 will be described below together with the description of the rotary mechanism 6.

The rotary mechanism 6 frictionally enables the rotation of the throttle lever 4 while allowing the throttle lever 4 to instantaneously return from the high-rotation position toward the idling position in conjunction with the operation on the trigger lever 5 (trigger-type structure). The rotary mechanism 6 includes: a rotating member 16 connected to the fitting portion 10 of the throttle lever 4 by a bolt 14 and a nut 15 to be rotated therewith; a cylindrical shaft 17; and a gear member 18 loosely fitted into the cylindrical shaft 17 of the rotating member 16.

A first end of the shaft 17 of the rotating member 16 is inserted into the fitting portion 10 of the throttle lever 4 at a position outside the case 2. A second end of rotating member 16 is positioned within the case 2. A substantially pear-shaped flange 19 is provided on the second end of the shaft 17. A connecting section 20 at which the Bowden cable (not shown) from a throttle mechanism of the carburetor is provided at a top side of the flange 19. The Bowden cable extends from the connecting section 20 through a lower slant surface 19A of the flange 19 toward the right side (a carburetor side) in FIG. 2.

A first return spring 21 provided by a torsion coil spring is provided on the rotating member 16 adjacent to the second end of the shaft 17. An end of the first return spring 21 is engaged with an upper slant surface 19B of the flange 19 and the other end is engaged to the inside of the case 2. Thus, by virtue of the spring force of the first return spring 21 and a tension applied by the Bowden cable, the rotating member 16 and the throttle lever 4 integrated with the rotating member 16 are constantly biased anti-clockwise in FIG. 2.

When the throttle lever 4 is turned clockwise in FIG. 2, the throttle lever 4 is positioned at a high-rotation side. When the throttle lever 4 is turned anticlockwise in FIG. 2, the throttle lever 4 is returned to an idling side. Incidentally, the throttle lever 4 is positioned at an idling position in FIG. 2.

As shown in FIG. 3, an elastic member 22 provided by a plate spring and a washer 23 are interposed between the flange 19 of the rotating member 16 and the gear member 18 while being inserted to the shaft 17. The elastic member 22 is positioned adjacent to the flange 19 and the washer 23 is positioned adjacent to the gear member 18. The elastic member 22 produces a predetermined frictional force between the flange 19 and the gear member 18 and provides frictional engagement therebetween. The frictional force is adjusted to be greater than the biasing force, i.e. the sum of the spring, force of the first return spring 21 and the tension applied by the Bowden cable.

in other words, when the throttle lever 4 is turned toward a higher-rotation side while the gear member 18 is locked by a below-described lock lever 24, the throttle lever 4 is operated against both of the biasing force and the frictional force. On the other hand, when the throttle lever 4 is turned toward the idling side, the throttle lever 4 is operated against an operation load in which the biasing force is subtracted from the frictional force. Further, since the frictional force is sufficiently greater than the biasing force, the throttle lever 4 operated to a predetermined position is not returned toward the idling side by virtue of the frictional force. Thus, the throttle lever 4 can be retained at the predetermined position after being operated in the same manner as a conventional friction type throttle lever.

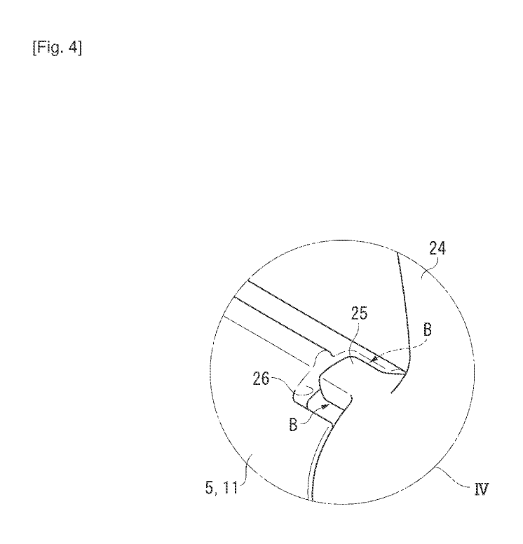

The lock lever 24 is disposed concentrically with the cylindrical portion 11 of the trigger lever 5. As shown in FIG. 4 enlarging a primary part in FIG. 1, an axially projecting projection 25 is provided on a base end of the lock lever 24. A recess 26 for receiving the projection 25 is provided on the cylindrical portion 11. The recess 26 is sized larger than the projection 25 to provide a predetermined amount of backlash B against the opposing surfaces in a rotary direction. The lock lever 24 is biased toward the gear member 18 (i.e. anticlockwise in FIG. 2) by a concentric press spring 27 provided by a torsion spring. Accordingly, the backlash B is created on the side shown in FIG. 4.

On the other hand, a pair of engaging claws 28 are provided on an end of the lock lever 24 while being vertically spaced apart. The engaging claws 28 project toward the gear member 18. When the lock lever 24 turns toward the gear member 18 by the biasing force of the press spring 27, the engaging claws engage with tooth surfaces engraved on the gear member 18 to lock the movement of the gear member 18.

At this time, the rotation of the lock lever 24 toward the gear member 18 is effected by gripping the trigger lever 5 together with the outer pipe. A shown in FIG. 2 and turning the trigger lever 5 anticlockwise. Specifically, the position of the recess 26 is moved by turning the trigger lever 5. Then, the press spring 27 presses the lock lever 24 in conjunction with the movement, so that the lock lever 24 is turned toward the gear member 18.

However, even after the lock lever 24 is engaged with the gear member 18, the trigger lever 5 keeps being operated until the backlash B at the position shown in FIG. 4 is substantially completely eliminated and the backlash B is produced at the opposite position (see a dotted line in FIG. 4). When the gear member 18 is locked, the throttle lever 4 can be frictionally operated as described above.

On the other hand, a second return spring 29 provided by a torsion spring is provided on the cylindrical portion 11 of the trigger lever 5. The second return spring 29 biases the trigger lever 5 clockwise in FIG. 2. The spring force of the second return spring 29 is greater than the spring force of the press spring 27. Thus, when the grip of the trigger lever 5 is released, the trigger lever 5 is immediately lowered again by the second return spring 29 to return the recess 26 to the original position. Due to the difference in the spring forces of the respective springs 27, 29, the recess 26 presses the projection 25, so that the lock lever 24 is turned clockwise to be disengaged with the gear member 18.

In this state, since the gear member 18 is no more locked by the lock lever 24, the gear member 18 is enabled to turn together with the rotating member 16 and the throttle lever 4 via the elastic member 22. In other words, since the rotating member 16 is constantly biased toward the idling side by the first return spring, all of the throttle lever 4, the rotating member 16 and the gear member 18 instantaneously returns to the idling side. Thus, the rotary mechanism 6 instantaneously returns the throttle lever 4 toward the idling side by releasing the trigger lever 5 to provide a trigger type accelerator.

Incidentally, since the spring force of the press spring 27 is smaller than the spring force of the second return spring 29, the lock lever 24 does not lock the gear member 18 when the trigger lever 5 is not gripped. Further, the spring force of the press spring 27 works in a direction against the second return spring 29 when the trigger lever 5 is operated. Accordingly, the trigger lever 5 is operated against the difference between the spring forces of the springs 27, 29, thereby reducing the operation load.

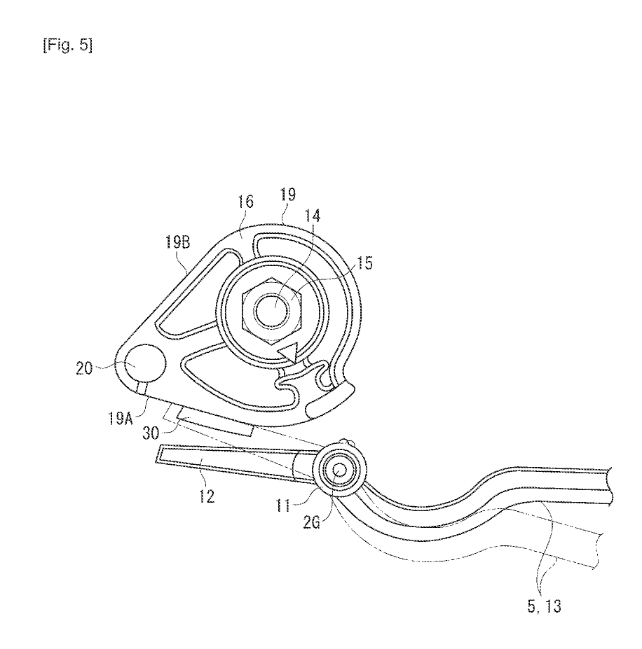

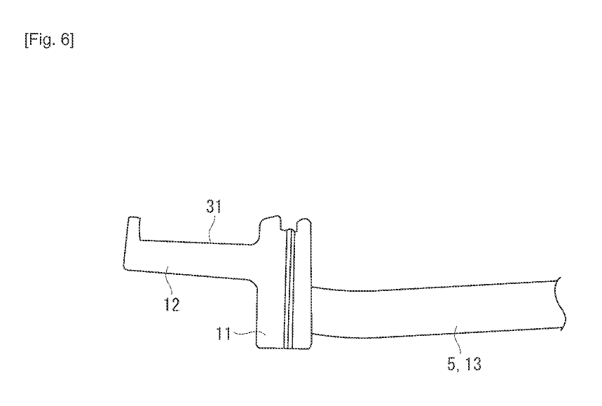

Incidentally, as shown in FIGS. 5 and 6, an engagement projection 30 projecting toward the trigger lever 5 is provided on the lower slant surface 19A of the flange 19 constituting the rotating member 16. On the other hand, an engagement cut 31 is provided on the engagement arm 12 of the trigger lever 5. When the trigger lever 5 is released and is biased clockwise in the figure by the second return spring 29, the engagement cut 31 engages with the engagement projection 30 to disable the rotary operation of the rotating member 16, i.e. the rotary operation of the throttle lever 4. The above arrangement is provided to prevent an inadvertent operation on the throttle lever 4.

The operation and the movement of the accelerator will be described below again.

In order to increase the output of the engine in the idling state, an operator grips the trigger lever 5 together with the outer pipe A and turns the trigger lever 5. The above operation disengages the engagement cut 31 of the trigger lever 5 from the engagement projection 30 to enable the operation on the throttle lever 4 and locks the gear member 18 by the lock lever 24. At this time, the gripping of the trigger lever 5 is maintained against the spring force of the second return spring 29. However, since the spring force is small as compared to the tension applied by the Bowden cable on the trigger lever in the Patent Literature 1, even a long duration of the gripping is not so much of a burden on an operator.

Subsequently, while the gear member 18 is locked, the throttle lever 4 is operated to a desired position on the high-rotation side. At this time, since the throttle lever 4 is frictionally engaged with the locked gear member 18 via the elastic member 22, after once operated, the operating position of the throttle lever is retained by the frictional force generated by the elastic member 22. Accordingly, it is not required to manually support the throttle lever 4 to prevent a position shift of the throttle lever 4 during the operation, thereby mitigating the stress on an operator even after a long duration of the operation.

Further, when the grip over the trigger lever 5 is loosened during the operation, the trigger lever 5 is drawn back by the second return spring 29. However, when the trigger lever 5 is turned to the maximum, since the backlash B is created at a side opposite to an original side, the lock lever 24 can be kept not interfered within the range of the backlash B, so that the lock lever 24 is not immediately disengaged with the gear member 18. Accordingly, slight fluctuations caused on the trigger lever 5 can be tolerated and the reduction of the engine output on account of sensitive reaction of the lock lever 24 can be prevented, thereby improving usability of the trigger lever 5.

It is only required to release the trigger lever 5 in order to return the throttle lever 4 from the high-rotation position to the idling position. Thus, the trigger lever 5 can be automatically returned by the second return spring 29. Further, since the spring force of the second return spring 29 is greater than the spring force of the press spring 27, the lock lever 24 can also be automatically returned to release the lock of the gear member 18. Accordingly, in addition to the gear member 18, all of the rotating member 16 and the throttle lever 4 integrated with the gear member 18 via the elastic member 22 can be instantaneously returned to the idling side by virtue of the spring force of the first return spring 21.

### Second Exemplary Embodiment

A second exemplary embodiment of the invention will be described below with reference to the attached drawings. It should be understood that the same members and components or the members or components having the same functions as those described in the above first exemplary embodiment will be denoted by the same reference numerals as those in the first exemplary embodiment to omit or simplify the description thereof. In the following, an arrangement different from that in the first exemplary embodiment will be mainly described.

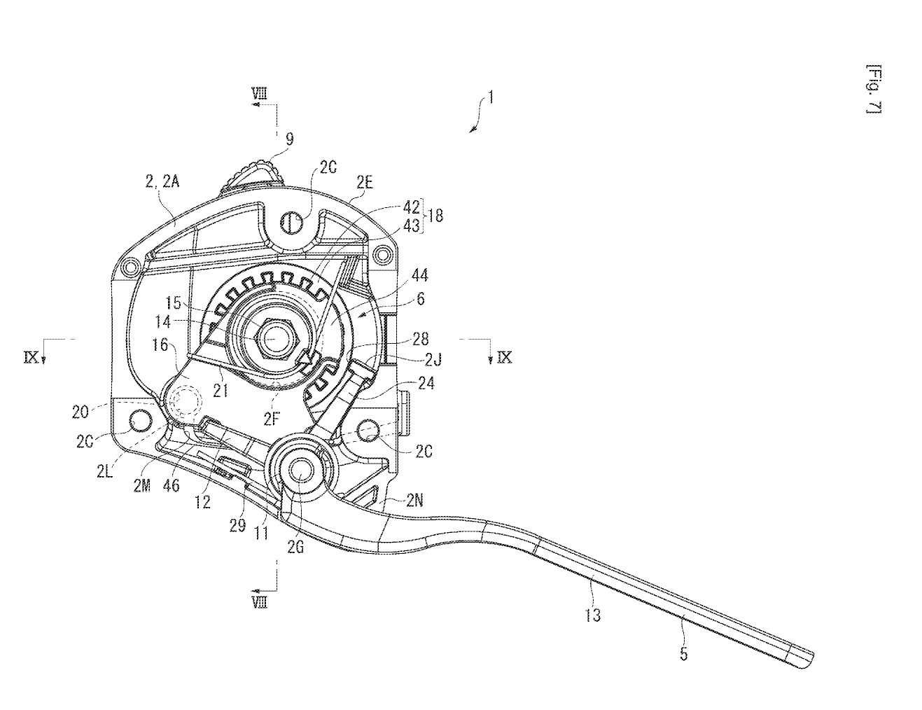

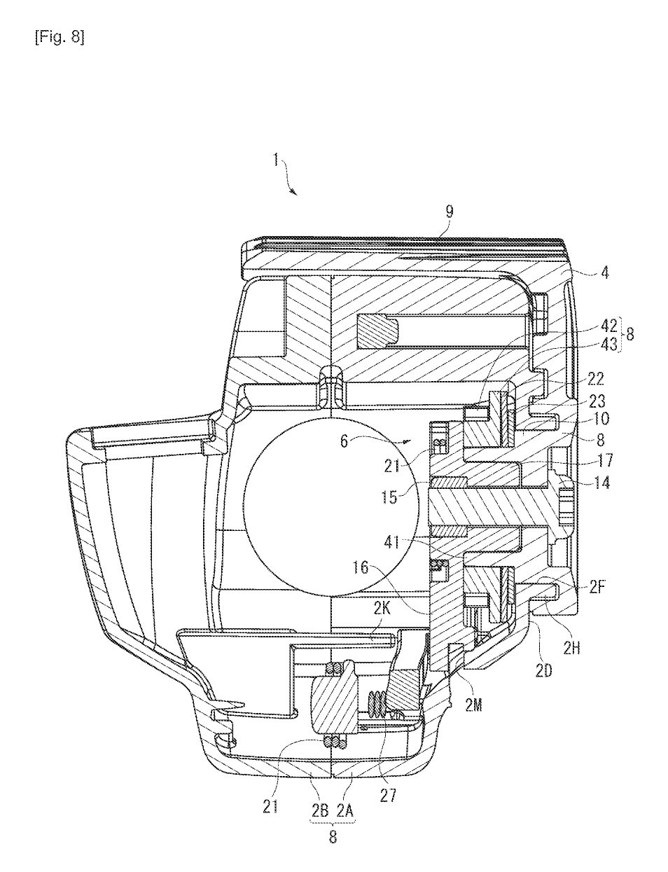

As shown in FIGS. 7, 8 and 9, an opening 2F in which fitting portion 10 of the throttle lever 4 is fitted is provided on the case member 2A constituting the case 2. The opening 2F in this exemplary embodiment is provided by a hollow portion of a case-side cylindrical portion 2H that extends outward by a predetermined dimension from a lateral side 2D of the case member 2A. An outer circumference of the fitting portion 10 is in slide contact with an inner circumference of the opening 2F. Since the contact area of the slide-contact portion is sufficiently large as compared with that in the first exemplary embodiment, a shaky movement of the throttle lever 4 relative to the case member 2A can be restrained.

A lever-side cylindrical portion 41 that extends toward the rotating member 16 is provided on the fitting portion 10 of the throttle lever 4. An outer diameter of the lever-side cylindrical portion 41 is smaller than an outer diameter of the fitting portion 10. In this exemplary embodiment, a washer 23, an elastic member 22 and a gear member 18 are inserted around the lever-side cylindrical portion 41. A shaft 17 extending from the rotating member 16 toward the throttle lever 4 is inserted inside the lever-side cylindrical portion 41. The shaft 17 and the lever-side cylindrical portion 41 are mutually fixed by a bolt 14 and a nut 15 so as to be rotated as a unit around the same rotary axis as in the first exemplary embodiment.

At this time, the washer 23, the elastic member 22 and the gear member 18 are provided in a space between a step portion formed between the lever-side cylindrical portion 41 and the fitting portion 10 and a lateral portion of the rotating member 16 axially opposed thereto. The gear member 18 is pressed toward the lateral portion of the rotating member 16 by the elastic force of the elastic member 22 to be frictionally engaged.

According to the above arrangement, the (fitting portion 10 of the) throttle lever 4 is fitted to the case member 2A and the lever-side cylindrical portion 41 is projected inward relative to the case member 2A, so that the washer 23, the elastic member 22, the gear member 18 and the rotating member 16 can be sequentially attached to the lever-side cylindrical portion 41, thereby facilitating the assembly work.

The gear member 18 of this exemplary embodiment includes a gear portion 42 meshing with the lock lever 24 and a disk 43 that is integrated with the gear portion 42 and is pressed by the elastic member 22. The outer diameter of the disk 43 is larger than the outer diameter of the gear portion 42. Accordingly, a larger-diameter elastic member 22 that corresponds to the size of the disk 43 is used.

A fastening force of the bolt 14 and the nut 15 is defined so that an appropriate pressing force (i.e. a frictional force against the disk 43) required for operating the throttle lever 4 is generated. However, when a small-diameter member is used as the elastic member 22, the elastic member 22 is not elastically deformed when the bolt 14 and the nut 15 are fastened to a certain extent, thus failing to provide a sufficient pressing force. Further, when the bolt 14 and the nut 15 are fastened beyond a certain degree, the elastic member 22 causes sudden great deformation to generate an excessive pressing force. Accordingly, sufficient margin for the defined fastening force cannot be provided, thus deteriorating assembly efficiency. In contrast, when the large-diameter elastic member 22 is used, the elastic member 22 is favorably deformed in accordance with the fastening force to vary the pressing force and the variation ratio is not excessively large, so that sufficient margin can be provided for the fastening force, thus further facilitating the assembly work.

Though the engagement arm 12 is integrated with the trigger lever 5 in this exemplary embodiment, the engagement arm 12 in this exemplary embodiment is provided by a member separate from the trigger lever 5 and is integrated with the lock lever 24. Thus, the engagement arm 12 and the lock lever 24 are simultaneously moved in this exemplary embodiment, thus improving the interlocking properties. Accordingly, the engagement and disengagement of the engagement arm 12 against the rotating member 16 and the engagement and disengagement of the lock lever 24 against the gear member 18 can be made in a timely fashion, thereby providing further stable operation.

Further, the lock lever 24 is provided with a single one of the engaging claw 28 at an end of the lever. Since it is not necessary to bring a pair of the engaging claws 28 into simultaneous engagement as in the first exemplary embodiment, the gap between the engaging claw 28 and the gear surface of the gear member 18 to be engaged therewith can be lessened, so that less shaky engagement can be provided. In addition, the configuration of an engagement portion of the engaging claw 28 with the gear member 18 is an inverted trapezoid that is slightly widened toward an end thereof. The gear shape of the gear member 18 is also an inverted trapezoid that has larger gear end than the base thereof.

Since the shapes of the gear member 18 and the engaging claw 28 are inverted trapezoid, the gap between the engaging claw 28 and the gear surface of the gear member 18 when being meshed can be further lessened. Accordingly, the shakiness at the engaged portions can be further reduced, so that the shakiness of the rotating member 16 (and consequently the throttle lever 4) that is frictionally engaged with the gear member 18 can be restrained, thereby correctly adjusting the accelerator of the engine.

A first rib 2J corresponding to a movement locus of the engaging claw 28 is provided inside the case member 2A. When the lock lever 24 is to be operated by operating the trigger lever 5, the lock lever 24 is inclined toward the first rib 2J in accordance with a gripping condition of the trigger lever 5 and a pressing direction by the press spring 27. In this exemplary embodiment, since the first rib 2J is provided adjacent to the engaging claw 28 and the engaging claw 28 is abutted to the first rib 2J to keep the lock lever 24 from inclination, so that the engaging claw 28 is engaged with the gear member 18 without being shifted in the axial direction.

On the other hand, a planar portion 44 corresponding to the rotatable range of the throttle lever 4 is provided at a part of an outer circumference of the rotating member 16 by a predetermined width along a circumferential direction thereof. The width of the planar portion 44 is defined so that the gear of the gear member 18 is substantially concealed. Thus, when the engaging claw 28 of the lock lever 24 is engaged with the gear member 18, the engaging claw 28 is opposed to the planar portion 44 on a side of the gear member 18 in the axial direction and is opposed to the above-described disk 43 of the gear member 18 on the other side. In other words, the axial movement of the engaging claw 28 is restrained by the disk 43 and the planar portion 44, so that the engaging claw 28 does not need to disengage from the gear member 18.

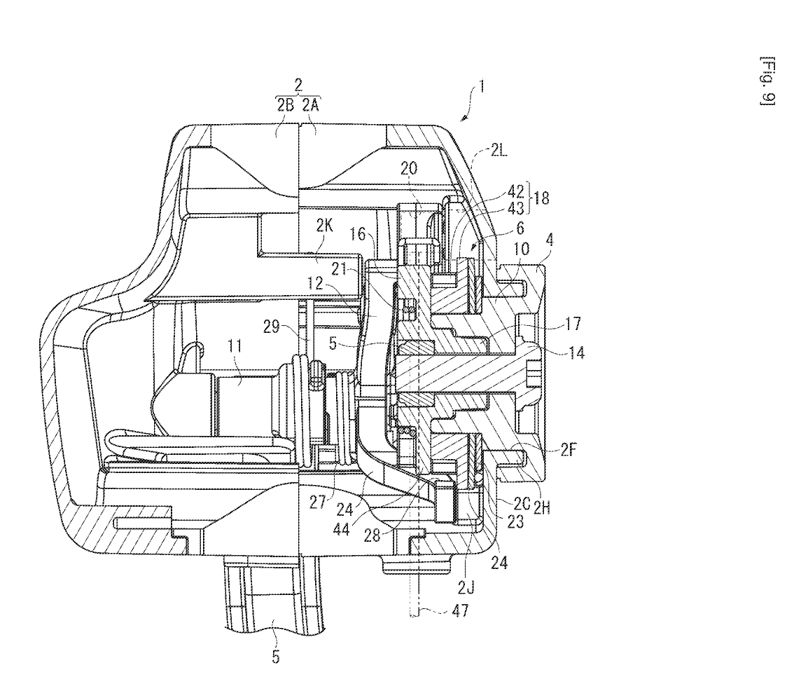

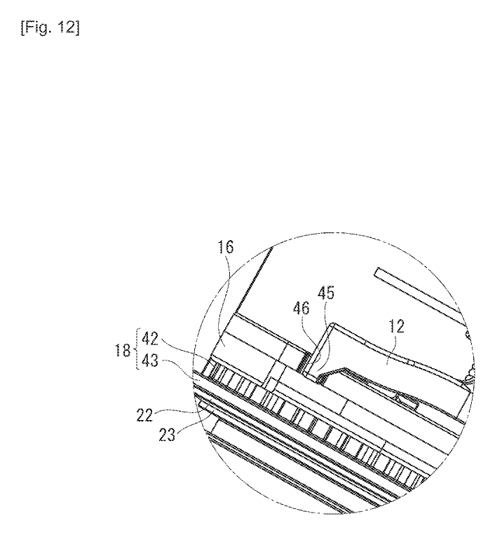

Further, as shown in FIG. 9, a part of the integrated lock lever 24 and the engagement arm 12 that serves as the rotary shaft is spaced apart from the engaging claw 28 in a direction away from the throttle lever 4. Thus, the lock lever 24 and the engagement arm 12 are not superposed with the rotating member 16 in plan view but is offset toward the cylindrical portion 11 of the trigger lever 5. Accordingly, the lock lever 24 defines a curve from a bonding portion 48 of the lock lever 24 and the engagement arm 12 to the engaging claw 28. Further, as shown in FIG. 12, the engagement claw 12 has an engagement projection 45 (described below) projecting from a distal end in the direction of the rotary axis, the engagement projection 45 being engaged with an engagement recess 46 provided on a lower slant surface 19A of the rotating member 16 to lock the rotating member 16.

Further, a second rib 2K that is provided close to and opposed to an end of the engagement arm 12 projects inside the cover member 2B so that the engagement projection 45 does not come out of the engagement recess 46 in the direction of the rotary axis. In contrast to the lock lever 24, the engagement arm 12 is inclined away from the rotating member 16 according to the gripping condition of the trigger lever 4. However, the inclination is prevented by abutting the engagement arm 12 to the second rib 2K, thereby keeping the engagement projection 45 from being detached from the engagement recess 46.

Since the lock lever 24 and the engagement arm 12 are offset, the Bowden cable 47 can be detached and attached from the side of the case member 2A. The rotating member 16 is provided with a connecting section 20 in which a cylindrical stopper (not shown) is provided at an end of the Bowden cable 47. The connecting section 20 is opened toward the case member 2A. The case member 2A is provided with an installation hole 2L for the stopper to be installed at a position corresponding to the connecting section 20 and a slit 2M for receiving the Bowden cable 47.

In other words, in order to avoid the interference against the Bowden cable 47 that is installed from the case member 2A, the bonding portion 48 provided by a base end of the lock lever 24 and the engagement arm 12 is offset toward the cylindrical portion 11 (i.e. toward a first side in the rotary axis direction) along the rotary axis direction relative to the engaging claw 28 and the engagement projection 45 provided at an end thereof. With the above arrangement, the exchange and the like of the Bowden cable 47 can be conducted from an outer side of the case member 2A (i.e. a second side in the rotary axis direction) without disassembling the accelerator 1.

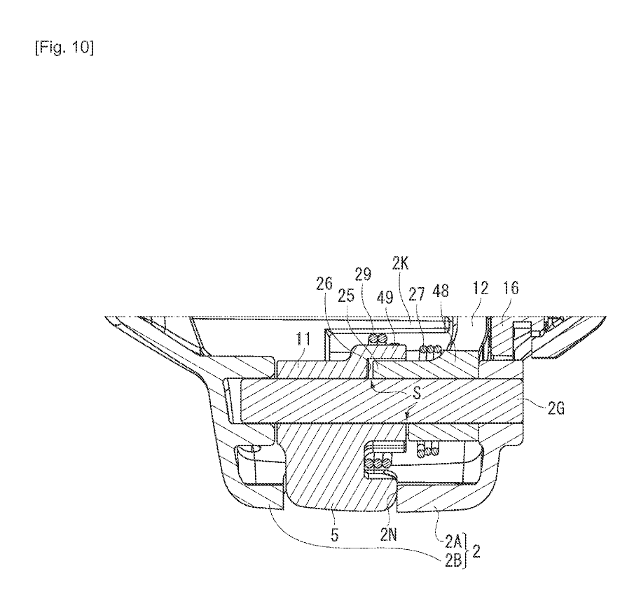

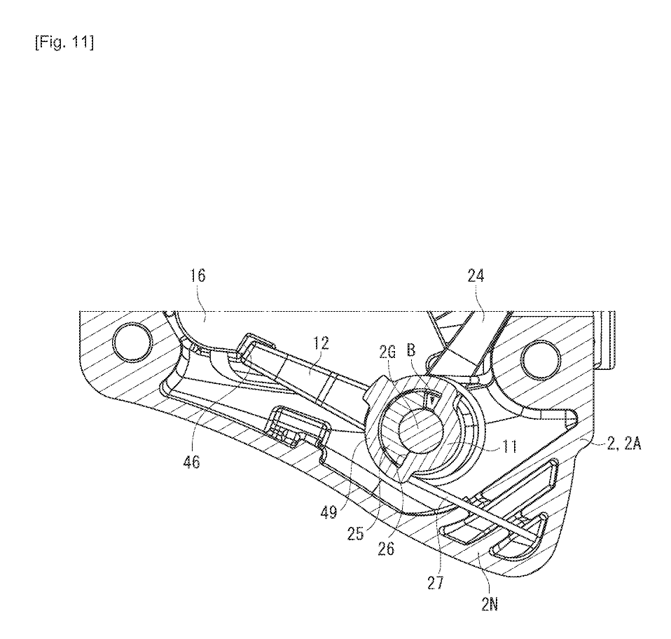

As shown in FIGS. 10 and 11, an abutment portion 2N that is abutted to the trigger lever 5 in the rotary axis direction is provided on a lower side of the case member 2A. When the trigger lever 5 is abutted to the abutment portion 2N, a space S is formed between the cylindrical portion 11 (rotary axis inserted to a shaft axis 2G) and the bonding portion 48 (rotary axis of the integrated engagement arm 12 and the lock lever 24). Since the space S is secured and the cylindrical portion 11 of the trigger lever 5 is not in contact with the bonding portion 48, the rotation of the lock lever 24 and the engagement arm 12 are not hindered by the cylindrical portion 11, so that the lock lever 24 and the engagement arm 12 can be smoothly moved.

The cylindrical portion 11 of this exemplary embodiment is provided with a covering portion 49 that covers the projection 25 entering the recess 26 near the bonding portion 48. The covering portion 49 keeps foreign objects from entering into between the projection 25 and the recess 26, so that the backlash B can be securely maintained and durability of the trigger lever 5, the lock lever 24 and the engagement arm 12 can be improved.

It should be understood that the scope of the invention is not limited to the above-described exemplary embodiment, but includes modifications as long as an object of the invention can be achieved.

Though a plate spring is employed as the elastic member, the elastic member according to the invention may be provided by a coil spring or an elastic member of a resin such as synthetic rubber and natural rubber.

The flange 19 and the elastic member may not be directly contacted. For instance, plate may be interposed between the flange 19 and the elastic member, the plate being pressed to be contacted with an opposing surface of the flange 19 to generate a predetermined frictional force. At this time, the material and the shape of the plate may be determined as desired in accordance with the shape and the material of the flange 19 and the elastic member. Further, a radial tooth surfaces extending from a rotation center to an outside may be formed on the opposing surfaces of the plate and the flange 19, In this arrangement, the teeth on the tooth surfaces overcome with each other during the rotary operation to cause a click, so that the operability of the throttle lever 4 can be improved.

Though a torsion spring is used as the first and the second return springs 21, 29 and the press spring 27, these springs may be provided by any type of springs other than torsion springs.

In the above-described embodiments, the rotating member 16 is biased toward the idling position by the first return spring 21 and the tension applied by the Bowden cable. However, when a throttle mechanism of the carburetor is designed so that the Bowden cable is not applied with a tension toward the idling side, the rotating member may be biased only by the return spring. Alternatively, the rotating member may be biased only by the tension applied by the Bowden cable. The biasing means of the rotating member may be suitably designed in accordance with the throttle mechanism on the carburetor and the like.

Though the throttle lever 4 and the rotating member 16 are concentrically disposed and are integrated to be interlocked, the throttle lever and the rotating member may be rotated around separate rotation axes. In this case, a first gear is provided on the throttle lever and a second gear is provided on the rotating member, the first and the second gears being meshed with each other so that the throttle lever and the rotating member are interlocked.

### INDUSTRIAL APPLICABILITY

An accelerator according to the invention can be suitably applied to a portable work machine such as a brushcutter and a chainsaw.

### REFERENCE SINGS LIST

1 . . . accelerator
2 . . . case
2H . . . case-side cylindrical portion
2J . . . first rib
2K . . . second rib
2N . . . abutment portion
4 . . . throttle lever
5 . . . trigger lever
12 . . . engagement arm
13 . . . grip
14 . . . bolt
15 . . . nut
16 . . . rotating member
17 . . . shaft
18 . . . gear member
20 . . . connecting section
22 . . . elastic member
24 . . . lock lever
41 . . . lever-side cylindrical portion
42 . . . gear portion
43 . . . disk
44 . . . planar portion
47 . . . Bowden cable
B . . . backlash
S . . . space

1. An accelerator that adjusts an output of an engine, the accelerator comprising a throttle lever that is turned, characterized by:
a rotating member that is rotated together with the throttle lever;
a gear member that is loosely and concentrically fitted to the rotating member;
a lock lever that is engaged with the gear member to lock a movement of the gear member;
a trigger lever that moves the lock lever; and
an elastic member that frictionally engages the rotating member and the gear member,
wherein the throttle lever is biased toward an idling position within an output adjustment range of the engine, and a frictional force generated by the elastic member between the rotating member and the gear member is greater than a biasing force of the throttle lever toward the idling position.

2. The accelerator according to claim 1, wherein the trigger lever is provided with an engagement arm that is engaged with and disengaged from the rotating member in accordance with an operating condition on the trigger lever.

3. The accelerator according to claim 1, wherein the trigger lever is provided with a grip and an engagement arm that is provided as a body independent of the grip and is engaged with the rotating member, and the engagement arm and the lock lever are integrally provided.

4. The accelerator according to claim 1, wherein the trigger lever and the lock lever are concentrically turned and are engaged so that the trigger lever and the lock lever are interlocked, and a predetermined amount of backlash is created at an engaged portion of the trigger lever and the lock lever.

5. The accelerator according to claim 4, wherein the trigger lever is biased in a direction for returning from an operating position, the lock lever is biased in a direction for locking the gear member, and the biasing direction of the trigger lever and the biasing direction of the lock lever are opposite.

6. The accelerator according to claim 1, wherein the throttle lever, the rotating member, the gear member and the elastic member are concentrically turned.

7. The accelerator according to claim 6, wherein the throttle lever and the rotating member are mutually connected by a bolt and a nut that are screwed along a rotary axis direction, a lever-side cylindrical portion extending toward the rotating member is provided on the throttle lever, the rotating member is provided with a shaft extending toward the throttle lever, the gear member and the elastic member are inserted to an outer circumference of the lever-side cylindrical portion, and the shaft of the rotating member is inserted to an inside of the lever-side cylindrical portion.

8. The accelerator according to claim 1, wherein a base end of the lock lever is offset to a first side in the rotary axis direction relative to a distal end thereof, a connecting section at which a Bowden cable for transmitting a movement of the throttle lever to the engine is connected is provided on the rotating member, and the Bowden cable is attachable and detachable through a second side of the rotary axis direction.

9. The accelerator according to claim 1, wherein the gear member is provided with a gear portion to which the lock lever is engaged and a disk that has a diameter larger than a diameter of the gear portion and is in frictional engagement with the elastic member, the gear portion and the disk being integrated.

10. The accelerator according to claim 1, wherein a planar portion that covers an engagement portion of the lock lever that is engaged with the gear member is provided on the rotating member.

11. The accelerator according to claim 1, further comprising:
a case for housing the rotating member, the gear member, the elastic member and the lock lever, and
a first rib that is adjacent to and opposed to the lock lever in the rotary axis direction is provided inside the case.

12. The accelerator according to claim 1, further comprising:
a case for housing the rotating member, the gear member, the elastic member and the lock lever, wherein the trigger lever is provided with an engagement arm that is housed in the case and is engaged with the rotating member, and
a second rib that is adjacent to and opposed to the engagement arm in the rotary axis direction is provided inside the case.

13. The accelerator according to claim 1, further comprising:
a case for housing the rotating member, the gear member, the elastic member and the lock lever, wherein the trigger lever is provided with a rotary portion in the case and a grip at a portion extending toward an outside of the case, the case is provided with an abutment portion that is in contact with the grip in the rotary axis direction, and a space is formed between a rotary shaft of the trigger lever and a rotary shaft of the lock lever when the grip is in contact with the abutment portion.
